(19) United States
(12) Patent Application Publication
(10) Pub. No.: US 2024/0109638 A1
(43) Pub. Date: Apr. 4, 2024

(54) AUTONOMOUS AIRBORNE CARBON DIOXIDE CAPTURING ASSEMBLY AND METHOD OF USE

(71) Applicant: Robert W. Carter, Rogers, AR (US)

(72) Inventor: Robert W. Carter, Rogers, AR (US)

(21) Appl. No.: 17/956,090

(22) Filed: Sep. 29, 2022

(51) Int. Cl. B64B 1/30; F25J 1/00

(52) U.S. Cl. CPC B64B 1/30; F25J 1/0027; B64C 2201/022; B64C 2201/146

(57) ABSTRACT

An autonomous airborne carbon dioxide capturing assembly for carbon dioxide sequestration includes a plurality of airships each including a propulsion and navigation system, a sensor, and a carbon dioxide (CO₂) capture and liquefaction module. The sensor measures CO₂ concentrations. A computer is operationally engaged to the propulsion and navigation system, the sensor, the CO₂ capture and liquefaction module, a positioning transceiver, and a communications transceiver. The computer automates decision-making and selectively actuates the propulsion and navigation system for controlled flight to a target area, to selectively actuate the CO₂ capture and liquefaction module to capture and to liquefy CO₂ from air at the target area, and to selectively actuate the propulsion and navigation system for controlled flight to a CO₂ storage facility for offloading of the CO₂.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to carbon dioxide capturing assemblies and more particularly pertains to a new carbon dioxide capturing assembly for carbon dioxide sequestration. The present invention discloses a carbon dioxide capturing assembly that is airborne, mobile, highly efficient, and scalable.

### (2) Description of Related Art Including Information Disclosed Under 37 CFR 1.97 and 1.98

The prior art relates to carbon dioxide capturing assemblies, which includes various devices and methods for capturing carbon dioxide (CO₂). Perhaps the most relevant prior art is U.S. Pat. No. 10,364,718, which claims the use of metal organic frameworks for capturing CO₂ from a vehicle's exhaust gasses. The vehicle could include an airship, per the present invention, but this prior art reference does not teach capturing of CO₂ from ambient air for depleting atmospheric capturing CO₂.

### BRIEF SUMMARY OF THE INVENTION

An embodiment of the disclosure meets the needs presented above by generally comprising a plurality of airships. Each airship comprises a propulsion and navigation system, a sensor, a carbon dioxide (CO₂) capture and liquefaction module, a positioning transceiver, a communications transceiver, and a computer, all of which are attached to a frame of the airship. The sensor is configured to measure CO₂ concentrations. The positioning transceiver is Global Positioning System (GPS) enabled. The computer is operationally engaged to the propulsion and navigation system, the sensor, the CO₂ capture and liquefaction module, the positioning transceiver, and the communications transceiver. The computer is programmed for automated decision-making and thus is enabled to selectively actuate the propulsion and navigation system for vertical takeoff and controlled flight to a target area, to selectively actuate the CO₂ capture and liquefaction module to capture and to liquefy CO₂ from air at the target area, and to selectively actuate the propulsion and navigation system for controlled flight to, and vertical landing at, a CO₂ storage facility for offloading of the CO₂.

Another embodiment of the disclosure includes an autonomous airborne carbon dioxide capturing system, which comprises a plurality of airships, as described above. The autonomous airborne carbon dioxide capturing system also comprises a plurality of satellites and a server. The server is programmed for automated decision-making and is in communicative engagement with the computer and the plurality of satellites. The server is enabled to generate an electronic map of CO₂ concentrations and to communicate the electronic map to the computer, enabling the computer to prioritize target areas and to sequentially select target areas for CO₂ capture based on the electronic map of CO₂ concentrations and position data of other members of the plurality of airships received via the communications transceiver.

Yet another embodiment of the disclosure includes a method of sequestering carbon dioxide comprising a provision step, which entail providing a plurality of airships, a plurality of satellites, a plurality of CO₂ storage facilities, and a server, according to the specification above. A deployment step of the method entails deploying the plurality of airships and the plurality of satellites. A connection step of the method entails communicatively engaging the server to the computer, the plurality of satellites, and the plurality of CO₂ storage facilities. A first continuation step of the method is monitoring the plurality of airships and a second continuation step is servicing the airships, as may be required.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a block diagram of an autonomous airborne carbon dioxide capturing assembly according to an embodiment of the disclosure.

FIG. 2 is an autonomous airborne carbon dioxide capturing system according to an embodiment of the disclosure.

FIG. 3 is a flow diagram for a method utilizing an embodiment of the disclosure.

### DETAILED DESCRIPTION OF THE INVENTION

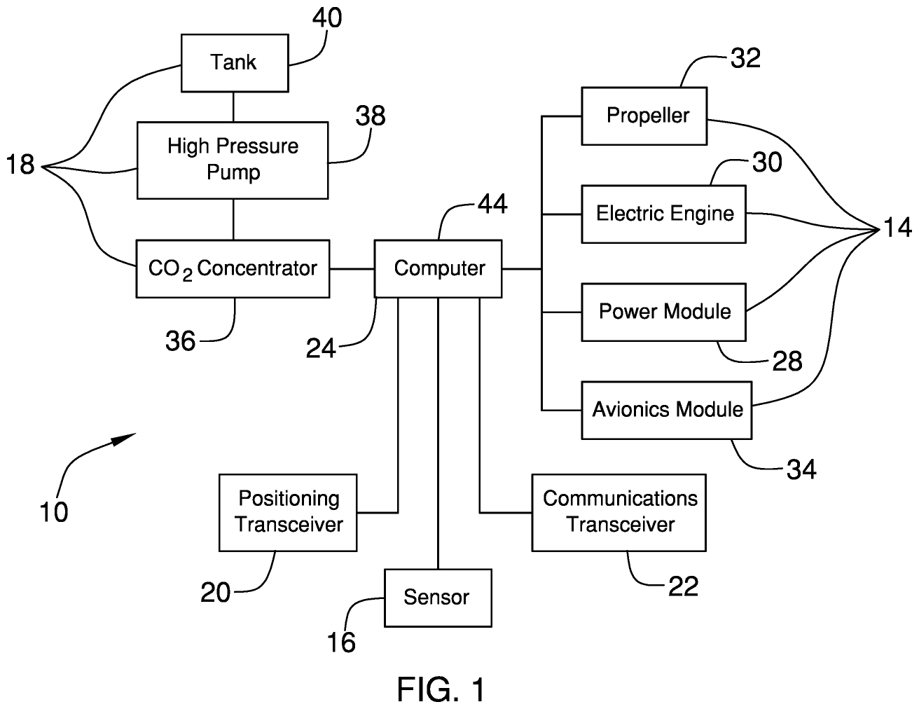

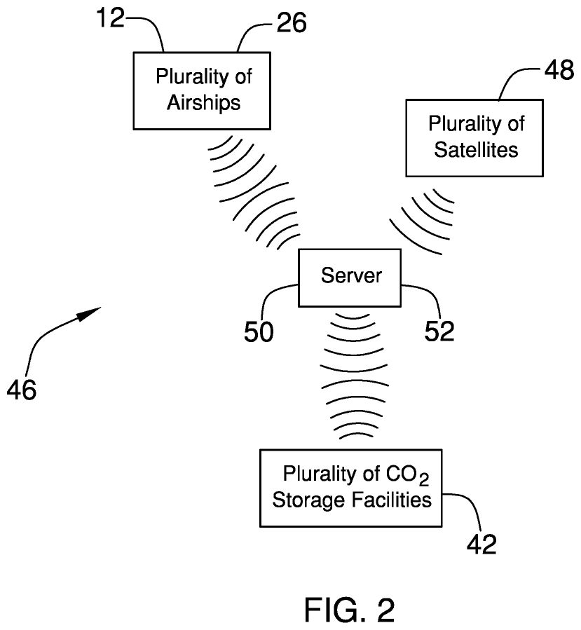

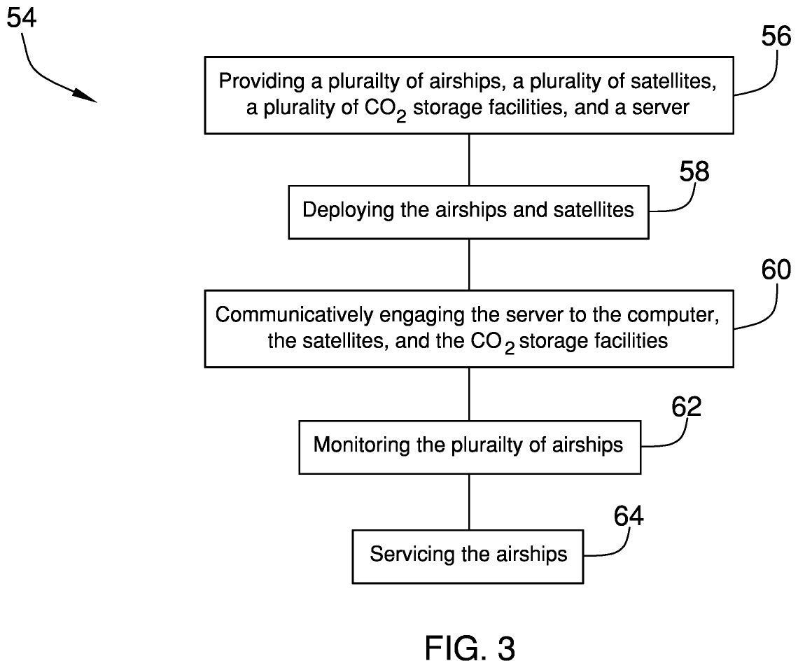

With reference now to the drawings, and in particular to FIGS. 1 through 3 thereof, a new carbon dioxide capturing assembly embodying the principles and concepts of an embodiment of the disclosure and generally designated by the reference numeral 10 will be described.

As best illustrated in FIGS. 1 through 3, the autonomous airborne carbon dioxide capturing assembly 10 generally comprises a plurality of airships 12. Each airship 12 comprises a propulsion and navigation system 14, a sensor 16, a carbon dioxide (CO₂) capture and liquefaction module 18, a positioning transceiver 20, a communications transceiver 22, and a computer 24, all of which are attached to a frame 26 of the airship 12. The propulsion and navigation system 14 comprises a power module 28, which may comprise one or more of a rechargeable battery, a solar panel, and a fuel cell, an electric engine 30, to which a propeller 32 is operationally engaged, and an avionics module 34. The electric engine 30 selectively rotates the propeller 32 to propel the airship 12. The present invention anticipates airships 12 of a variety of configurations, which are capable of vertical takeoffs and vertical landings, such as, but not limited to, lighter than air airships, tilt rotor fixed wing airships, helicopters of various types, and the like. The airship 12 may comprise an un-manned aerial vehicle remotely or autonomously controlled.

The CO₂ capture and liquefaction module 18 is operationally engaged to the power module 28 and comprises a CO₂ concentrator 36, a high-pressure pump 38, and a tank 40. The CO₂ concentrator 36 is configured to generate a substantially pure CO₂ mixture from air collected in a target area. The high-pressure pump 38 generates a liquified substantially pure CO₂ mixture, and the tank 40 is used to store the liquified substantially pure CO₂ mixture. The present invention anticipates use of a variety of CO₂ capturing techniques known to those skilled in this art, such as, but not limited to, sorbents configured to selectively attach to CO₂ under high pressure and to release CO₂ under low pressure, size exclusion membrane filters, combinations thereof, and the like.

The sensor 16 is configured to measure CO₂ concentrations. The positioning transceiver 20 is Global Positioning System (GPS) enabled. The computer 24 is operationally engaged to the propulsion and navigation system 14, the sensor 16, the CO₂ capture and liquefaction module 18, the positioning transceiver 20, and the communications transceiver 22. The computer 24 is programmed for automated decision-making and thus is enabled to selectively actuate the propulsion and navigation system 14 for vertical takeoff and controlled flight to the target area, to selectively actuate the CO₂ capture and liquefaction module 18 to capture and to liquefy CO₂ from the air at the target area, and to selectively actuate the propulsion and navigation system 14 for controlled flight to, and vertical landing at, a CO₂ storage facility 42 for offloading of the CO₂.

The computer 24, by being interfaced with the avionics module 34, is enabled to monitor and to avoid air traffic, avoid no-fly zones, and the like. Communication between the airships 12 also is enabled, allowing data and other information to be exchanged, such as, but not limited to, traffic data, airship 12 location, weather, tornado warnings, NOAA Storm Prediction Center reports, and the like. The airships 12 follow FAA traffic rules, comply with Federal Acquisition Regulations (FAR) and Acquisition Management System (AMS) regulations, and monitor air traffic from Air Traffic Controllers. When an airship 12 requires maintenance or experiences a malfunction, the computer 24 directs the airship 12 to land in a safe location and a notification is sent via the communications transceiver 22.

Dynamic power distribution programming code 44, which is positioned on the computer 24, enables the computer 24 to selectively power the electric engine 30, the avionics module 34, the sensor 16, the CO₂ concentrator 36, the high-pressure pump 38, the positioning transceiver 20, and the communications transceiver 22, thereby minimizing draw on the power module 28.

The present invention also anticipates an autonomous airborne carbon dioxide capturing system 46, which comprises a plurality of airships 12, as described above. The autonomous airborne carbon dioxide capturing system 46 also comprises a plurality of satellites 48 and a server 50. The server 50 is programmed for automated decision-making and is in communicative engagement with the computer 24 and the plurality of satellites 48. The server 50 is enabled to generate an electronic map 52 of CO₂ concentrations and to communicate the electronic map 52 to the computer 24, enabling the computer 24 to prioritize target areas and to sequentially select target areas for CO₂ capture based on the electronic map 52 of CO₂ concentrations and position data of other members of the plurality of airships 12 received via the communications transceiver 22.

The autonomous airborne carbon dioxide capturing system 46 also may comprise a plurality of CO₂ storage facilities 42, which is in communicative engagement with the server 50. Each CO₂ storage facility 42 is enabled for autonomous offloading of liquified CO₂ from the airship 12. The server 50 is enabled to communicate locations and availability of each CO₂ storage facility 42 to the computer 24, enabling the computer 24 to select the nearest CO₂ storage facility 42 and to actuate the propulsion and navigation system 14 for controlled flight thereto for autonomous offloading of the liquified CO₂.

In use, the autonomous airborne carbon dioxide capturing assembly 10 enables a method of sequestering carbon dioxide 54 comprising a provision step 56, which entails providing a plurality of airships 12, a plurality of satellites 48, a plurality of CO₂ storage facilities 42, and a server 50, according to the specification above. A deployment step 58 of the method 54 entails deploying the plurality of airships 12 and the plurality of satellites 48. A connection step 60 of the method 54 entails communicatively engaging the server 50 to the computer 24, the plurality of satellites 48, and the plurality of CO₂ storage facilities 42. A first continuation step 62 of the method 54 is monitoring the plurality of airships 12 and a second continuation step 64 is servicing the airships 12, as may be required.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An autonomous airborne carbon dioxide capturing assembly comprising a plurality of airships, each airship comprising:
a propulsion and navigation system attached to a frame of the airship;
a sensor attached to the frame and being configured for measuring carbon dioxide (CO₂) concentrations;
a CO₂ capture and liquefaction module attached to the frame;
a positioning transceiver attached to the frame, the positioning transceiver being Global Positioning System (GPS) enabled;
a communications transceiver attached to the frame; and
a computer attached to the frame and being operationally engaged to the propulsion and navigation system, the sensor, the CO₂ capture and liquefaction module, the positioning transceiver, and the communications transceiver, the computer being programmed for automated decision-making, such that the computer is enabled for selectively actuating the propulsion and navigation system for vertical takeoff and controlled flight to a target area, for selectively actuating the CO₂ capture and liquefaction module for capturing and liquefying CO₂ from air at the target area, and for selectively actuating the propulsion and navigation system for controlled flight to, and vertical landing at, a CO₂ storage facility for offloading of the CO₂.

2. The autonomous airborne carbon dioxide capturing assembly of claim 1, further including the propulsion and navigation system comprising:
a power module;
an electric engine;
a propeller operationally engaged to the electric engine, such that the electric engine selectively rotates the propeller for propelling the airship; and
an avionics module.

3. The autonomous airborne carbon dioxide capturing assembly of claim 2, wherein the power module comprises one or more of a rechargeable battery, a solar panel, and a fuel cell.

4. The autonomous airborne carbon dioxide capturing assembly of claim 2, wherein the CO₂ capture and liquefaction module is operationally engaged to the power module and comprises:
a CO₂ concentrator configured for generating a substantially pure CO₂ mixture from the air collected in the target area;
a high-pressure pump for generating a liquified substantially pure CO₂ mixture; and
a tank for storing the liquified substantially pure CO₂ mixture.

5. The autonomous airborne carbon dioxide capturing assembly of claim 4, further including dynamic power distribution programming code positioned on the computer enabling the computer for selectively powering the electric engine, the avionics module, the sensor, the CO2 concentrator, the high-pressure pump, the positioning transceiver, and the communications transceiver, thereby minimizing draw on the power module.

6. An autonomous airborne carbon dioxide capturing system comprising:
a plurality of airships, each airship comprising:
a propulsion and navigation system attached to a frame of the airship,
a sensor attached to the frame and being configured for measuring carbon dioxide (CO₂) concentrations,
a CO₂ capture and liquefaction module attached to the frame,
a positioning transceiver attached to the frame, the positioning transceiver being Global Positioning System (GPS) enabled,
a communications transceiver attached to the frame, and
a computer attached to the frame and being operationally engaged to the propulsion and navigation system, the sensor, the CO₂ capture and liquefaction module, the positioning transceiver, and the communications transceiver, the computer being programmed for automated decision-making, such that the computer is enabled for selectively actuating the propulsion and navigation system for vertical takeoff and controlled flight to a target area, for selectively actuating the CO₂ capture and liquefaction module for capturing and liquefying CO₂ from air at the target area, and for selectively actuating the propulsion and navigation system for controlled flight to, and vertical landing at, a CO₂ storage facility for offloading of the CO₂;
a plurality of satellites, each satellite being enabled for measuring CO₂ concentrations; and
a server programmed for automated decision-making, the server being in communicative engagement with the computer and the plurality of satellites, such that the server is enabled for generating an electronic map of CO₂ concentrations and for communicating the electronic map to the computer, enabling the computer for prioritizing target areas and for sequentially selecting target areas for CO2 capture based on the electronic map of CO₂ concentrations and position data of other members of the plurality of airships received via the communications transceiver.

7. The autonomous airborne carbon dioxide capturing system of claim 6, further including a plurality of CO₂ storage facilities, each CO₂ storage facility being enabled for autonomous offloading of liquified CO₂ from the airship, the server being in communicative engagement with the plurality of CO₂ storage facilities, such that the server is enabled for communicating locations and availability of each CO₂ storage facility to the computer, enabling the computer for selecting the nearest CO₂ storage facility and for actuating the propulsion and navigation system for controlled flight thereto for autonomous offloading of the liquified CO₂.

8. A method of sequestering carbon dioxide comprising the steps of:
providing a plurality of airships, each airship comprising:
a propulsion and navigation system attached to a frame of the airship,
a sensor attached to the frame and being configured for measuring carbon dioxide (CO₂) concentrations,
a CO₂ capture and liquefaction module attached to the frame,
a positioning transceiver attached to the frame, the positioning transceiver being Global Positioning System (GPS) enabled,
a communications transceiver attached to the frame, and
a computer attached to the frame and being operationally engaged to the propulsion and navigation system, the sensor, the CO₂ capture and liquefaction module, the positioning transceiver, and the communications transceiver, the computer being programmed for automated decision-making, such that the computer is enabled for selectively actuating the propulsion and navigation system for vertical takeoff and controlled flight to a target area, for selectively actuating the CO₂ capture and liquefaction module for capturing and liquefying CO₂ from air at the target area, and for selectively actuating the propulsion and navigation system for controlled flight to, and vertical landing at, a CO₂ storage facility for offloading of the CO₂;
providing a plurality of satellites, each satellite being configured for measuring CO₂ concentrations;
providing a plurality of CO₂ storage facilities, each CO₂ storage facility being enabled for autonomous offloading of liquified CO₂ from the airship;
providing a server programmed for automated decision-making, the server being configured for communicatively engaging the computer, the plurality of satellites, and the plurality of CO₂ storage facilities;
deploying the plurality of airships and the plurality of satellites;
communicatively engaging the server to the computer, the plurality of satellites, and the plurality of CO₂ storage facilities, such that the server is enabled for generating an electronic map of CO₂ concentrations and for communicating the electronic map to the computer, enabling the computer for prioritizing target areas and for sequentially selecting target areas for CO2 capture based on the electronic map of CO₂ concentrations and position data of other members of the plurality of airships received via the communications transceiver, such that the server is enabled for communicating locations and availability of each CO₂ storage facility to the computer, enabling the computer for selecting the nearest CO₂ storage facility and for actuating the propulsion and navigation system for controlled flight thereto for autonomous offloading of the liquified CO₂;
monitoring the plurality of airships; and
servicing the airships, as may be required.
